(19) United States
(12) Patent Application Publication
(10) Pub. No.: US 2026/0359813 A1
(43) Pub. Date: Nov. 12, 2026

(54) HYBRID DATABASE APPROACH TO REPRESENT A BLOCKCHAIN STATE OF THE WORLD

(71) Applicant: Oracle International Corporation, Redwood Shores, CA (US)

(72) Inventor: Carlo Innocenti, Wakefield, MA (US)

(21) Appl. No.: 19/203,317

(22) Filed: May 9, 2025

(51) Int. Cl. G06Q 20/40; G06Q 20/38

(52) U.S. Cl. CPC G06Q 20/401; G06Q 20/382

(57) ABSTRACT

A first block in a blockchain network can be processed by validating a first blockchain transaction and committing the first proposed changes to a first world state database. The first proposed changes can be committed to a second world state database in response to processing the first block. A second block can be processed in the first world state database in response to processing the first block. A third block can be processed by validating the third blockchain transaction and committing the third proposed changes to the second world state database. The third proposed changes can be committed to the first world state database in response to processing the third block.

### FIELD

The present application relates to the state of the world for a blockchain, and, more specifically, to a hybrid database approach to represent a blockchain state of the world.

### BACKGROUND

### Permissioned Blockchain System

In a permissioned blockchain system, blockchain clients submit transaction requests to the blockchain system to change a database referred to as the world state. The changes are recorded in the blockchain as blockchain transactions. A blockchain system is decentralized and distributed, meaning the blockchain system has multiple copies of both the blockchain and the world state. A blockchain system comprises multiple peers, some or all of which are responsible for participating in forming and approving blockchain transactions and/or recording the blockchain transactions in their respective blockchain copies.

The world state comprises world state records that each contain one or more values. A world state record may be, for example, a key-value pair that represents currency tokens spent and generated for a transaction. Changes to the world state can be specified using read-write set semantics. Under read-write semantics, a blockchain transaction specifies a change to a world state record using a read-write set that specifies the version of the world state record to which to apply a change (“read version”) and the new actual value resulting from the change (“write value”). The read version is typically the most recent version to which to apply a change. For example, a change to a world state record changes the record value from 1000 to 900. The record value of 1000 is version #11 for the record. The read-write set for the change includes read version #11 and write value 900.

A blockchain transaction may change the values of one or more world state records. A blockchain transaction includes a “read set” and a “write set”. The read set includes read versions of world state records information accessed by the smart contract to implement the intended business logic. The write set includes the write values for the world state records changed by the blockchain transaction. A read set and a write set may contain other information about the changes. For example, a read set may include the read value corresponding to a read version.

A Hyperledger Fabric is a permissioned distributed ledger blockchain platform, which can be considered a permissioned blockchain system. The Hyperledger Fabric stores data in multiple shapes and formats differently in each node that is part of a network. A ledger, structured as a sequence of blocks, is always the source of truth, specifically the ledger managed by an ordering service, which is made of ordering nodes. The ordering service maintains a ledger for each channel stored on the file system. High availability is obtained by distributing such a ledger across multiple ordering nodes, often spread across multiple data centers and organizations.

Peers maintain their own copy of the ledger as well. Client applications at the peer may only view the corresponding peer's ledger copy. The information in the peer's ledger is similar to what is known to the ordering service, with the exception that peers also store whether each transaction has been flagged as valid or invalid in their ledger. As for the ordering service, high availability is obtained by distributing peers joined to the same channel across availability domains, data centers, and/or organizations.

### State Database

The state of the world, also referred to as the State Database (StateDB), is the current snapshot of the data as it has been created and modified by the information contained in each validated transaction of each block. The StateDB is the primary way to interact with data in a blockchain. For example, smart contracts find and modify data in the StateDB. The StateDB can be rebuilt at any time by scanning information in blocks, with the exception of private data, which can only be gossiped across authorized peers.

The StateDB is stored in repositories that are designed to be fast rather than fault-tolerant because the StateDB needs to answer queries quickly. For example, the StateDB is typically persisted by each peer in a fast, embedded key/value (k/v) pair storage engine, such as an embedded database. High availability is achieved through the replication of the StateDB across peers and through the ability to be rebuilt if/when necessary from the ledger.

The physical storage of the ledger is simple in that blocks are persisted to disk by each peer. The blocks may be indexed so files do not need to be scanned to retrieve the correct block number. A ledger does not support any sophisticated search or query functionality, and it is most often ignored by smart contracts, client applications, and business logic.

The StateDB, on the other hand, typically has the burden to support all business logic built on the blockchain network. In many cases, like in a Hyperledger Fabric, the StateDB supports the ability to be searched and queried, which implies it requires internal non-trivial indexing structures to be able to perform such operations quickly and in a scalable manner. Smart contracts typically rely on the StateDB for analyzing information, making decisions, and persisting new information. Even if the ledger remains the source of truth of any such information, the StateDB takes the brunt of exposing all data in a useful and reliable manner.

The StateDB is typically much smaller than the overall ledger in terms of overall information it manages and physical size because the StateDB is a snapshot of the state of the world. However, the kind of operations the StateDB supports imposes more challenging technical requirements. For example, it is a challenge to run a randomly complicated Structured Query Language (SQL) expression against an embedded database engine (“embedded DB”) that may store hundreds of millions of rows of data, while at the same time processing new data that is supposed to be processed at rates of thousands per second.

A permissioned blockchain system relies by default on a combination of an embedded DB, such as BerkeleyDB (as the underlying key/value (k/v) pair storage engine), and an embedded self-contained structured query language engine, such as SQLite (as the higher-level SQL abstraction). This combination typically works well and is able to deal with large numbers of k/v pairs and high throughput/low latency requirements. However, the combination is stressed heavily when dealing with large datasets (approaching the half TB mark), when dealing with large values in its k/v pairs, when dealing with potential system crashes during the completion of write transactions, and other stressors. When the embedded DB breaks due to, for example, bugs, disk errors, interrupted write operations, etc., it may take a long time to rebuild the corresponding StateDB from the ledger if the number of blocks and number of transactions are high. Also, while the StateDB is being rebuilt, the peer maintaining the StateDB is not serviceable, cannot be used for endorsements on up-to-date data, and cannot process new incoming blocks. For large systems where the embedded DB size is measured in hundreds of GBs, it may take days or even months before a StateDB gets entirely rebuilt from the ledger.

The presence of multiple peers servicing the same channel alleviates the high availability problem because not all peers typically need to undergo a StateDB recovery at the same time. However, it is not unusual if a bug triggered the StateDB degradation, then multiple or even all peers need to undergo StateDB recovery at the same time. It is also not unusual that the client applications are often written to rely on a small handful of peers to perform specific operations. It is also foreseeable that the internal embedded DB data structures at some point may reach their limits in relationship to the size of the stored data. After all, an embedded k/v pair storage engine is typically not designed to persist TBs of data, and the query engine on top of it is also not designed to perform efficiently against TBs of data.

A solution would seem to replace the StateDB persistence implementation with something like an actual database system, such as a relational database management system (DBMS), that is more robust and designed to deal with data that may grow almost arbitrarily large. While an actual database system would provide a reliable and scalable approach, the drawback is speed. Storing k/v pairs is very fast in an embedded storage engine, such as BerkeleyDB, LevelDB, or other embedded storage engines, mostly because the storage operation does not do a lot of work. Ultimately, the speed of the storage operation is bound by how fast the underlying database system is at dealing with write operations. When dealing with more robust database systems that are not embedded DBs, many more layers come into the picture, with the first one being the client-server-client hops for each request, but also including more internal steps, which in the end is what makes the actual database a more reliable and scalable solution to start with. Given the way blockchain systems work, the added latency of persisting the StateDB to a relational DBMS degrades both throughput and latency as experienced from the blockchain client's point of view. In tests run for such degradation, latency as experienced by a blockchain client increased by at least one order of magnitude when dealing with a relational DBMS for StateDB persistence, and throughput became 3-5 times slower, where a lot of the latency and speed depends on the specific design of the smart contract, configuration of the permissioned blockchain system, and design of the client application. These issues make the switch from an embedded DB to a relational DBMS for StateDB persistence not particularly appealing because many large customers of permissioned blockchain systems are already pushing throughput and latency requirements to their limits when relying on an embedded DB under the cover.

The approaches described in this section are approaches that could be pursued, but not necessarily approaches that have been previously conceived or pursued. Therefore, unless otherwise indicated, it should not be assumed that any of the approaches described in this section qualify as background merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In order to describe the manner in which advantages and features of the disclosure can be obtained, a description of the disclosure is rendered by reference to specific embodiments thereof which are illustrated in the appended drawings. These drawings depict only example embodiments of the disclosure and are not therefore to be considered to be limiting of its scope.

The drawings may have been simplified for clarity and are not necessarily drawn to scale.

FIG. 1 depicts a blockchain system used to illustrate the hybrid database (HybridDB) approach to represent a blockchain state of the world.

FIG. 2 is a block diagram that depicts an example blockchain network using a HybridDB according to an example embodiment.

FIG. 3 is a flowchart of a method for a HybridDB approach to represent a blockchain state of the world according to an example embodiment.

FIG. 4 is a block diagram that illustrates a computer system upon which aspects of the illustrative embodiments may be implemented.

FIG. 5 is a block diagram of a basic software system that may be employed for controlling the operation of a computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

The illustrative embodiments provide a HybridDB for a permissioned blockchain system, such as a Hyperledger Fabric-based blockchain platform. In an embodiment, the HybridDB is a StateDB that is replicated to two different persistence engines by a permissioned blockchain system peer, such as to an embedded DB and to a relational DBMS. The embedded DB takes care of the stringent throughput and latency requirements as experienced by permissioned blockchain system clients, while the relational DBMS takes care of the resiliency, high availability, and scalability requirements of permissioned blockchain systems that deal with heightened recoverability requirements and/or deal with very large datasets.

In particular, the HybridDB typically maintains a fast StateDB (e.g., embedded DB) as a Primary StateDB in front and replicates blockchain transaction world state data to a Shadow StateDB (e.g., relational DBMS). The Shadow StateDB may lag behind the Primary StateDB in terms of committing blockchain transactions. However, the Shadow StateDB is still close enough that even if the fast Primary StateDB encounters a problem, the Shadow StateDB can become available almost immediately without any downtime. There may be some performance degradation using the Shadow StateDB in terms of block throughput and latency, but the StateDB will still be functional and continue to operate. While the Shadow StateDB is up and running, functionally processing blocks, the Primary StateDB can be repaired to bring it back up to the current height of processed blocks. Once the Primary StateDB is back up to speed, it can smoothly and transparently become the currently functioning StateDB, and the Shadow StateDB returns to processing blocks in the background without any downtime.

In an implementation, an embedded DB is configured as the Primary StateDB, and a relational database is configured as the Shadow StateDB, which is a shadow replication of the state of the world. Typically, the Primary StateDB is updated synchronously, and the Shadow StateDB is updated asynchronously. For example, for each block that hits the blockchain, the transactions in the block are considered synchronously stored into the embedded StateDB because the block is not considered finalized until it is actually stored in the ledger. To elaborate, after a transaction is validated, a write set of the validated transaction is written to the principally operating StateDB synchronously with writing the block to the ledger, where no other block is processed for the principally operating StateDB until the previous block is completely processed.

Once the block transactions are stored synchronously, the same transactions of the block are stored asynchronously in the relational StateDB. Storing the transactions in the relational StateDB may take longer, but it is operating behind the scenes. When the fast embedded StateDB goes down, the relational StateDB becomes the principally operating StateDB until the embedded StateDB is repaired. Only a slight delay may occur to allow the relational StateDB to catch up to processing the current block.

The switch between the Primary StateDB and the Shadow StateDB can occur when part of the write to the Primary StateDB fails as part of a commit pipeline due to an error, a timeout, etc. The switch can also occur during an execute phase, such as an endorsement phase, of the block transactions. For example, the switch may occur in response to a smart contract trying to pull data from the Primary StateDB and receiving an error or no response. Thus, the switch can occur in response to a problem with the Primary StateDB.

The switch can also occur when the Shadow StateDB is the principally operating StateDB in the synchronous pipeline and the Primary StateDB is the background StateDB in the asynchronous pipeline. In this case, the switch can be more proactive without waiting for a problem. A check of the ledgers for each StateDB can be performed before endorsement or commitment of transactions in a block. If the ledger of the Primary StateDB has reached the height of the Shadow StateDB, then the Primary StateDB can be swapped back to the synchronous pipeline. For example, each StateDB has the same height when the latest block processed from each StateDB is the same block.

Furthermore, a peer joining a blockchain network ledger can immediately become available by using another peer's Shadow StateDB that has already been populated. In this case, both a commit phase at that peer can be performed asynchronously using the other peer's StateDB, and the peer's local StateDB can be populated, such as recovered, asynchronously as it gets up to speed with the blockchain network ledger.

In a possible embodiment, a method can include receiving a first block including a first blockchain transaction, the first blockchain transaction including a first write set of first proposed changes to a world state. The method can include processing the first block by validating the first blockchain transaction and committing the first proposed changes to a first world state database.

The method can include committing, in response to processing the first block, the first proposed changes to a second world state database. The method can include processing a second block in the first world state database in response to processing the first block and regardless of the completion of committing the first proposed changes to the second world state database. The method can include detecting an event affecting the first world state database. The method can include, in response to detecting the event, receiving a third block including a third blockchain transaction, the third blockchain transaction including a third write set of third proposed changes to the world state. The method can include processing the third block by validating the third blockchain transaction and committing the third proposed changes to the second world state database. The method can include committing, in response to processing the third block, the third proposed changes to the first world state database.

Thus, the HybridDB includes two active StateDBs. One principally operating StateDB is responsible for serving synchronous requests, and another background StateDB that stays up to date behind the scenes and picks up the load if the front StateDB is in trouble. This avoids peer-level service interruptions and reduces the negative performance impact, which improves the operation of the peers and the underlying blockchain technology. For example, the HybridDB avoids problems that occur when a Primary StateDB is not able to deal with large ledgers. The use of the Shadow StateDB in the HybridDB further guards the system from a corrupted Primary StateDB that continues working and causes faulty checkpoints. The use of the Shadow StateDB in the HybridDB also avoids downtime when rebuilding a crashed or broken Primary StateDB.

### Exemplary Blockchain System

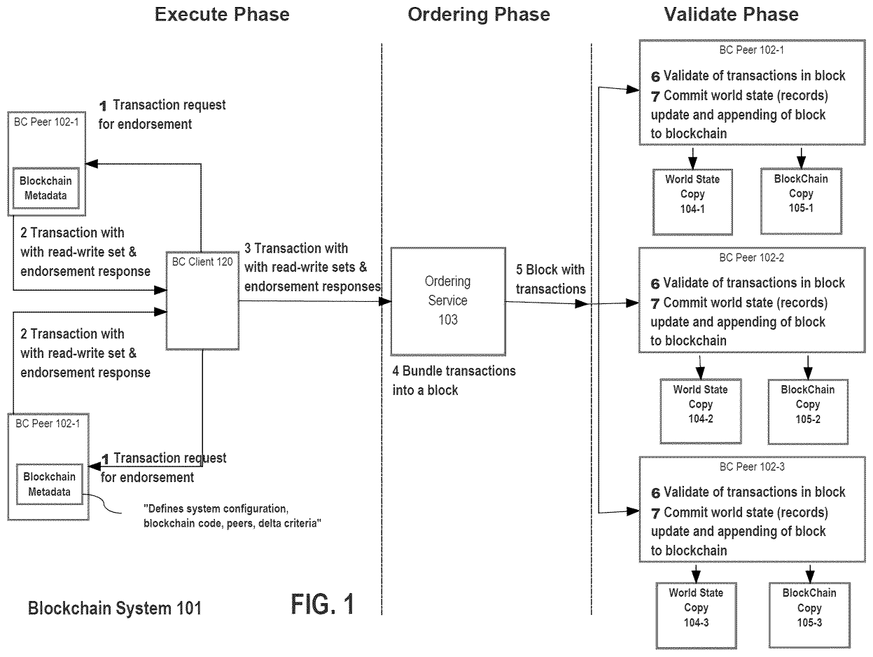

FIG. 1 depicts blockchain system 101, an illustrative blockchain system used to illustrate the HybridDB approach to represent a blockchain state of the world. Blockchain system 101 follows an approach referred to herein as the Execute-Order-Validate approach, the phases and steps of which are depicted in FIG. 1. As the name of the approach indicates, the phases include the Execute Phase, the Order Phase, and the Validate Phase. Each of these phases and the steps performed therein shall be explained in greater detail.

The blockchain system 101 includes peer computing nodes (“BC peers”) that participate in the Execute Phase and/or Validate Phase. BC peer 102-1 and BC peer 102-2 participate in the Execute Phase and the Validate Phase. BC peer 102-3 performs in only the Validate Phase. A computing node in a blockchain system that participates in the Validate Phase is referred to herein as a peer. A peer may also participate in the Execute Phase and/or the Ordering Phase. BC peers 102-1, 102-2, and 102-3 may be referred to herein collectively as BC peers 102.

The Ordering Phase is performed by an ordering service, which may include computing nodes that may or may not be peer nodes. Computing nodes that perform in the Ordering Phase are not depicted in FIG. 1.

As shall be explained in further detail, each of the peer nodes that participate in the Validate Phase may maintain a blockchain copy of the distributed blockchain of blockchain system 101 and a world state copy of the distributed world state of blockchain system 101. BC peer 102-1, 102-2, and 102-3 maintain both World State Copies 104-1, 104-2 & 104-3 and Blockchain Copies 105-1, 105-2, & 105-3, respectively. World State Copies 104-1, 104-2 & 104-3 can be stored in respective StateDBs and may be referred to collectively as the Distributed World State 104. Blockchain Copies 105-1, 105-2, & 105-3 may be referred to collectively as Distributed Blockchain 105.

### Blockchain Metadata

Each peer in the blockchain system 101 includes blockchain metadata, which defines the configuration and other aspects of the blockchain system 101. Blockchain metadata defines, inter alia, the peers of blockchain system 101, the endorsement policy, blockchain code, delta criteria, and other information. The blockchain metadata is stored in a way that supports versioning. Versions of blockchain metadata are tracked as the blockchain metadata is changed.

### Execute-Order-Validate Approach

Endorsers are the peers in a blockchain system that participate in the Execute Phase.

Not all peers participate in the Execute Phase. A peer that does not participate in the Execute Phase is referred to herein as a non-endorser peer.

A blockchain client sends a blockchain transaction request to each of the endorsers.

Each endorser simulates the blockchain transaction requested to generate a read-write set. The blockchain transaction, which includes the read-write sets generated by the endorsers, is sent to the ordering service.

In the Ordering Phase, the ordering service groups blockchain transactions generated by endorsers into ordered blocks. The ordered blocks are sent to the peers for processing in the Validate phase. In this phase, the peers perform validation checks on the block transactions in each of the blocks and commit valid transactions to the distributed world state and blocks to the distributed blockchain.

The steps performed in each phase are explained below and illustrated using the elements of the blockchain system 101 depicted in FIG. 1.

### Endorsement Phase

Step 1: Blockchain Client 120 transmits a blockchain transaction request to BC peer 102-1 and BC peer 102-2. The blockchain transaction may entail changes to multiple world state records.

In an embodiment of the present invention, the blockchain transaction is transmitted by remotely calling a smart contract on each of BC peer 102-1 and BC peer 102-2. The smart contract was recorded in Distributed Blockchain 105 as an approved function that can be invoked by a blockchain client on any endorser to request a blockchain transaction with blockchain system 101.

Step 2: BC peer 102-1 and BC peer 102-2 simulate the execution of the requested blockchain transaction on their respective copies of Distributed World State 104, which are World State Copy 104-1 and World State Copy 104-2. The simulation generates a read-write set. BC peer 102-1 and BC peer 102-2 each send an endorsement response that includes a digital signature generated by each based on certain content of the endorsement response. The endorsement response also includes data indicating whether the endorser endorses (i.e., approves) the blockchain transaction and the version of blockchain metadata at the time of endorsement. An endorsement response that approves a blockchain transaction is referred to herein as an endorsement. The endorsement responses are sent to Blockchain Client 120.

If the blockchain transaction request is transmitted by invoking a smart contract, the endorsement response includes an identity of the smart contract assigned by blockchain system 101 and the input arguments to the invocation of the smart contract.

Step 3: The Blockchain Client 120 collects the endorsement responses and packages the endorsement responses into a blockchain transaction. The blockchain transaction is sent to Ordering Service 103.

### Ordering Phase

Step 4: Ordering Service 103 receives the blockchain transactions sent by blockchain clients, including Blockchain Client 120, and organizes the blockchain transactions into ordered transaction blocks.

Step 5: The ordered transactions blocks are sent to all the peers of blockchain system 101. These are BC peers 102-1, 102-2, and 102-3.

### Validate Phase

Step 6: Upon receiving a transaction block, each peer of BC peers 102 independently validates each block transaction in a transaction block by performing various validation checks as follows. Each peer determines whether a block transaction has a sufficient number of endorsements according to an endorsement policy. The digital signatures from each endorser in the blockchain transaction are checked. Additional validation may also be performed on the read-write set of each blockchain transaction.

An endorsement policy may require that the endorsements satisfy a blockchain metadata version concurrency. That is, endorsements are made by peers that had the same blockchain metadata version (“at-endorsement-version”) when endorsements were made. The blockchain metadata concurrency check ensures, for example, that the same version of a smart contract was used for the blockchain transaction.

After performing the validation checks, each peer determines for each blockchain transaction in the transaction block whether the blockchain transaction is valid or invalid. The transaction block is modified to designate for each blockchain transaction whether the blockchain transaction is valid or invalid.

Step 7: E ach peer of BC peers 102 modifies world state records of the valid blockchain transactions in their respective copy of the world state. No change to the world state is made for an invalid blockchain transaction. Each peer appends the respective transaction block in the respective blockchain copy of the peer. Each peer commits both the change to their copy of the world state and the appending of the transaction block to their copy of the blockchain together. A transaction block includes blockchain transactions that are valid or invalid.

An Execute-Order-Validate approach is described in Jeet Ann Chacko, et al., entitled Why Do My Blockchain Transactions Fail? (ACM SIGM OD 2021), dated 8 Mar. 2021, the entire contents of which are incorporated herein by reference. Blockchain systems are also described in U.S. patent application Ser. No. 16/261,363, filed by Carlo Innocenti on Jan. 29, 2019, now U.S. Pat. No. 11,169,985, the entire contents of which are incorporated herein by reference (computing nodes are referred to therein as nodes).

### Hybrid Database

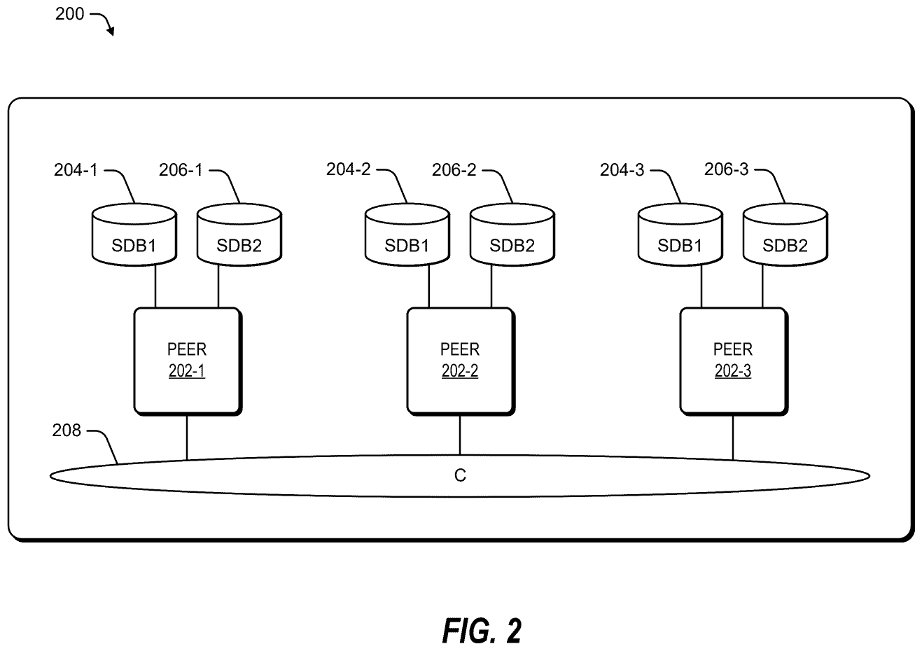

FIG. 2 is a block diagram that depicts an example blockchain network 200 using a HybridDB according to an example embodiment. The blockchain network 200 includes peers 202-1, 202-2, and 202-3 that communicate with each other over a channel 208. The channel 208 is a logical structure that allows a specific set of peers and applications to communicate with each other within a blockchain network, where a channel corresponds to a particular ledger. Each peer 202-1-202-3 communicates with respective first StateDBs 204-1-204-3, referred to as first StateDB s 204, and respective second StateDBs 206-1-206-3, referred to as second StateDBs 206. In an implementation, the first StateDBs 204 are Primary StateDBs, and the second StateDBs 206 are Shadow StateDBs.

The HybridDB is a StateDB that is replicated to two different persistence engines by a permissioned blockchain system peer. The StateDB is replicated by each peer 202 to a respective first StateDB 204 and second StateDB 206. The first StateDB 204 can be an embedded DB, and the second StateDB 206 can be a relational database system, but the roles may be swapped. Also, the first StateDB 204 and the second StateDB 206 may be the same type of database system or other types of database systems. The second StateDB 206 can be local to a peer 202 or can be accessed across a network, such as from a relational DBMS or from another peer, where two peers may write to the same second StateDB, such as in a commit phase.

For illustrative purposes, the first StateDB 204 will be referred to as an embedded StateDB or Primary StateDB, and the second StateDB 206 will be referred to as a relational StateDB or Shadow StateDB. An embedded StateDB is a fast world state database that is embedded into the blockchain network software. It is a k/v store for the StateDB. The embedded StateDB is integrated directly into the blockchain application, rather than being a standalone system. This means the embedded StateDB is embedded within an application's code and runs as part of the application itself. The embedded StateDB 204 takes care of the stringent throughput and latency requirements as experienced by permissioned blockchain system clients, while the relational StateDB 206 takes care of the resiliency, high availability, and scalability requirements of permissioned blockchain systems that deal with heightened recoverability requirements and/or deal with very large datasets.

In normal operational conditions, peers expose the embedded StateDB as a Primary StateDB for smart contract computation, and perform synchronous block commits, such as by processing blocks in series to commit world state records with validated transactions, to the same StateDB. In such normal conditions, the Primary StateDB is referred to as the Synchronous StateDB because it holds the current state of the ledger. It is synchronous because it processes blocks to provide a snapshot of the latest values of all assets and can be queried for the current state without traversing the entire blockchain. At the same time, peers perform asynchronous commits to a shadow relational StateDB as a Shadow StateDB. A synchronous commit operations have virtually no impact on the peers' performance, and they keep the shadow relational StateDB synchronized with the ledger and the embedded StateDB, or almost in sync, because the relational StateDB may fall behind in periods of high blockchain block commit throughput during normal operation. In such normal conditions, the Shadow StateDB is referred to as the asynchronous StateDB, because it may lag behind the current state of the ledger. The synchronous database processes each block in a series, such as serially or in turn, and does not wait for the asynchronous database to process a given block before the synchronous database moves on to the next block.

### State Database Switch

If, for any reason, read or write operations against the Primary StateDB start failing, a peer makes the Shadow StateDB become its synchronous StateDB, and the Primary StateDB becomes its asynchronous StateDB. At this point, smart contract operations and synchronous block commits work against the Shadow StateDB. Permissioned blockchain system clients may experience a performance degradation, such as higher latency, lower throughput of blockchain transactions, but the clients will not experience any service interruption by the peer(s) involved. The Primary StateDB moves to process commits in the asynchronous mode. If the error that triggered the swap was transient, the Primary StateDB will soon catch up to the current ledger height. If the error was longer-lasting, eventually the asynchronous block commit processing will be aborted, and human intervention may be required to understand why the embedded StateDB is failing and how to best recover it. During this period, the peer will keep using the Shadow StateDB for serving and processing requests coming to the peer, although with some level of degraded performance. If/when the Primary StateDB catches up to the current ledger's height, the peer restores things to their normal operational conditions, promoting the Primary StateDB to become the principally operating synchronous StateDB and reverting the Shadow StateDB to become the background asynchronous StateDB.

If at a peer's startup, the Primary StateDB is below the ledger's height, and the Shadow StateDB matches the ledger's height, the peer can immediately promote the Shadow StateDB to be the principally operating synchronous StateDB and can set the Primary StateDB to be the background asynchronous StateDB to run an asynchronous recovery. That implies that recovery of the Primary StateDB will happen asynchronously with no impact on the ability of the peer to serve the ledger involved if the Shadow StateDB is current with the ledger. Thus, for example, if a peer is restarted after deleting a compromised embedded StateDB, and the relational StateDB is up to date with the ledger height, the embedded StateDB will start an asynchronous rebuild. At the same time, requests are processed through the relational StateDB, which results in no impact on the peer's availability.

Vice versa, if at a peer's startup the Shadow StateDB is below the ledger's height, the Shadow StateDB covers the role of the background asynchronous StateDB and enters asynchronous recovery. At the same time, the Primary StateDB acts as the principally operating synchronous StateDB, even if it needs to recover. That implies that if a peer is switched to HybridDB mode when it already had a ledger and a StateDB associated with the peer, the relational StateDB will get asynchronously populated (which is an operation that will take a while when the ledger is large), and the peer will keep serving requests and performing operations as normal using the Primary StateDB during this phase.

To elaborate, using an example embodiment, for a HybridDB, a commit pipeline at a peer in a blockchain network is forked into two phases. One phase of the commit pipeline involves a synchronous pipeline that processes blocks sequentially. The synchronous pipeline processes a block by validating transactions in a block and committing the validated transactions to world state records in a principally operating StateDB, such as the Primary StateDB. The synchronous pipeline can also update and append the block to the blockchain.

The other phase of the commit pipeline involves an asynchronous pipeline that typically works against a background Shadow StateDB that is hot swappable with the Primary StateDB. The asynchronous pipeline is triggered when a block has cleared the synchronous pipeline after writing the block's validated transactions to the principally operating StateDB. The asynchronous pipeline then writes the write set of the block's validated transactions to the backup StateDB without requiring validation because the transaction was already validated in the synchronous pipeline. The StateDB in the asynchronous pipeline does not perform validation and waits for validation of the block in the synchronous pipeline.

Typically, the asynchronous pipeline commits the block's validated write set to the background Shadow StateDB behind the scenes and is ready to help in case of need. If the principally operating Primary StateDB is having problems, the Shadow StateDB becomes the principally operating StateDB in the synchronous pipeline. Thus, the synchronous pipeline switches from the Primary StateDB to the Shadow StateDB as the principally operating StateDB in response to an issue with the Primary StateDB. The synchronous pipeline can switch StateDBs in the middle of processing. Thus, the synchronous pipeline can validate a transaction, can determine there is an issue with the Primary StateDB, and can switch the principally operating StateDB to the Shadow StateDB on-the-fly without aborting the operation. The Primary StateDB can then become the background StateDB in the asynchronous pipeline while it is recovering and/or after it has been fixed and until it catches up to the current block.

As a particular example, block 10 may be in the synchronous pipeline while blocks 11 and 12 are waiting to get into the synchronous pipeline because the pipeline is not clear of block 10 yet. Block 10 goes through validation, and the validated transactions are written to the StateDB.

Block 10 is then pushed to the asynchronous pipeline, and block 11 is processed in the synchronous pipeline, which can occur before the asynchronous pipeline fully processes block 10. Block 12 can also be processed in the synchronous pipeline before the asynchronous pipeline fully processes block 10, which results in blocks 11 and 12 waiting for the asynchronous pipeline to process block 10. Thus, the asynchronous pipeline is asynchronous because it is asynchronous with the current state of the world. The line of waiting blocks in the asynchronous pipeline may grow longer while the synchronous pipeline keeps processing blocks without being blocked by the asynchronous pipeline. In other words, the asynchronous pipeline is asynchronous because it is not synchronous with the main commit pipeline. The peer is not affected, such as not delayed, by the asynchronous pipeline, which may be slower because it is using a slower process of writing to a database, such as a relational database that may be at least one network hop away from the peer and that involves additional processing steps.

In an implementation, a block is pushed to an asynchronous pipeline queue after the block clears the synchronous pipeline. The asynchronous queue is monitored for asynchronous processing of blocks. When a block is found in the queue, the asynchronous pipeline commits the block's validated write set to the Shadow StateDB.

### Customer Managed Hybrid Database

In a possible embodiment, a customer is responsible for specifying and maintaining which database system they want to use as the permissioned blockchain system HybridDB repository. The HybridDB can be configured as a new flavor of a StateDB that uses a basic Hyperledger Fabric configuration structure accessed by a peer node, also referred to as a peer. The HybridDB is supported by creating an embedded StateDB and a relational StateDB. To configure the relational database connection, at least two approaches are possible.

In a first approach for internal testing and development, the relational database connection string and credentials may be specified as part of the same peer's configuration (core.yaml) used to control other aspects of the peer. The password is in clear and stored on the peer's file system in this case.

In a second approach for production and/or customer-facing scenarios, the relational database connection and credentials are stored in encrypted format in a permissioned blockchain system metadata repository, similarly to how the same kind of information is stored for Rich History purposes. For example, an external database can store detailed information about the blockchain ledger's transactions on selected channels.

A user may also deploy database wallets to the peer's work root directory and reference a Transparent Network Substrate (TNS) alias as the connection string, where database wallets can be secure containers used to store authentication credentials, signing credentials, and trusted certificates.

A HybridDB configuration can happen through a permissioned blockchain system console User Interface (UI) or Application Programming Interface (API). The configuration can follow a User Experience (UX) equivalent to what is already supported for Rich History. In one implementation, the user can configure one HybridDB connection shared across a whole permissioned blockchain system instance. In the context of configuring such a connection, the user specifies a connection string and credentials, and optionally a database wallet. The peer's remote procedure call admin A PI is used to persist that information in the instance metadata repository. In another implementation, the user can enable HybridDB on a peer-level basis, where some peers may be configured to use HybridDB and other peers are not. The customer can also decide that all peers currently part of the instance and any future peers use HybridDB and rely on the specified database configuration. Peers whose configuration has been changed to use HybridDB, or whose HybridDB connection configuration has changed, may be restarted to make the new configuration take effect.

Instead of using a customer-managed HybridDB, a permissioned blockchain system can also manage the HybridDB. In this scenario, HybridDB support is selected at instance provisioning time. As part of that provisioning, a database system or an autonomous transaction processing instance is provisioned, which may not be visible or even accessible to the customer.

The user may still configure the enablement of HybridDB for all peers across the whole permissioned blockchain system instance, or on a peer-by-peer basis.

### Character String Limits

A relational database can have limits on the length of non-Large Object (LOB) character string columns, such as 4000 bytes in a standard configuration and 32767 bytes in an extended configuration. An autonomous relational database can be configured to work in extended configuration by default, but a user can switch it to revert to the standard style.

The following description uses an example standard configuration length of 4000 bytes and an extended configuration length of 32767 bytes, but other lengths are possible. While the permissioned blockchain system is able to dynamically adapt to the configured database style, a standard configuration can limit the size of the StateDB keys (not values) to 4000 bytes, which may translate into less than 4000 characters depending on which character encoding is used by the database, and what kind of keys the chaincodes use. To address this, the database can be run in extended configuration, or chaincodes, such as smart contracts, can use key sizes that are not longer than 4000 bytes in database allocation Even when the relational database is configured in extended style, users can be mindful to avoid using long StateDB keys, such as no longer than 32767 bytes. Even when HybridDB is not used and a relational database is not configured, it is helpful to use StateDB keys that are small because larger keys (for example, a key>1 KB in size may qualify as a larger key) may have a negative impact in terms of performance across the whole system but specifically in terms of an embedded StateDB.

The permissioned blockchain system supporting HybridDB can reject by default the creation of StateDB keys longer than 32767 bytes. The value can be changed to either make it bigger if the user needs to create longer keys and they don't have intention to use HybridDB, or smaller if the user wants to use HybridDB with a database in standard mode and chaincodes are prevented from erroneously creating keys larger than can be stored in a relational database.

If existing StateDB keys longer than the capacity of the underlying relational database already exist in a ledger (or get created due to an enforcement not matching the underlying relational database configuration), such keys, when replicated to the relational database, can be truncated and made unique by appending a hash.

### Monitoring Hybrid DB

Monitoring of the state of the HybridDB machinery can be accomplished through an A PI that can be consumed directly by administrators, or it can be inspected through a console UI. Monitoring is about exposing the state of the overall HybridDB system, whether it is enabled or not, and what the current states of the Primary StateDB and the Shadow StateDB are.

The principally operating StateDB, such as the synchronous StateDB, is the one that is reported as in a SYNC_COMM ITS state because it is the one that the commit pipeline waits for before declaring the operation complete in synchronous operation. The background database is typically reported as being in an ASYNC_COM MITS state, which means the commit pipeline is indeed pushing commits to it but not waiting for the provider to acknowledge the commits have completed.

Either StateDB, the Primary StateDB or Shadow StateDB, but not both, can be reported in ASYNC_RECOVERY state, which can only be for the secondary database, as it means that the StateDB in question has entered recovery mode at a peer's startup, but that recovery is being processed asynchronously without blocking the peer's behavior. Under normal conditions where HybridDB is not used, a peer is unable to process requests specific to a ledger whose StateDB is recovering.

If the state ASYNC_ABORTED is reported, that means that the asynchronous commit workflow has been permanently stopped, which is an indication of a persistent error while pushing data to the secondary StateDB or a symptom that the asynchronous block queue has reached capacity. A last error field, such as LastAsyncError, can explain what happened there. A way to get out of this situation is to restart the corresponding peer, ideally after having corrected the underlying issue, such as correcting a corrupted database provider, a bad database connection, bad database credentials, or any other underlying issue.

It is technically possible that in one channel, a Primary StateDB is in the SYNC_COMMITS state, and the Primary StateDB is in a different state in another channel, even if such is somewhat unusual. This can mean that, for some reason, access to some channel Primary StateDB tables is succeeding, while access to other tables is failing.

There is another scenario that may happen. Suppose the peer starts in “normal” HybridDB state (primary sync_commits, shadow async_commits); suppose that at some point the Primary StateDB fails; at that point the Shadow StateDB becomes the current stateDB (sync_commits) for the existing channels while the peer keeps trying to push blocks to the Primary StateDB for asynchronous processing (async_commits); now the user creates a new channel/joins the peer to a channel; when that happens, the peer realizes that it can't even create the basic StateDB structures in the Primary StateDB. In this case, the Shadow StateDB becomes the principally operating and only StateDB for that channel with no background StateDB defined.

That state of HybridDB for that new channel will be reported as SYNC_COMMITS for the principally operating StateDB provider, and UNDEFINED for the background StateDB. A peer restart (after an embedded DB fix) can restore the normal situation. Suppose the embedded StateDB is wiped out on peer restart. Initially, the Shadow StateDB (relational database) will become the current StateDB (sync_commits) for all channels, and the Primary StateDB (embedded DB) will be in async_recovery state across all channels. Eventually, the Primary StateDB would catch up to the current ledger height (some channels before others-depending on their sizes) and go back to be the principally operating StateDB (sync_commits), with the Shadow StateDB back to its normal async_commits state as a background StateDB.

### State Changes in Primary State DB and Shadow State DB

To elaborate on switching StateDBs, embodiments can provide for events for swapping sync_commits and async_commits states for the Primary StateDB and the Shadow StateDB. In normal operational conditions, when HybridDB is used, the Primary StateDB is the current StateDB processing endorsement requests and committing write sets of blockchain transactions in blocks in synchronous mode. The Shadow StateDB is not accessed for processing endorsements and just, in an asynchronous manner, processes the commits of incoming blocks already committed to the Primary StateDB. For example, endorsement requests involve sending transaction proposals to designated peers for simulation and approval before the transaction is submitted for ordering and commitment to the ledger. Committing blocks refers to the process of adding validated blocks of transactions to the blockchain ledger, which involves verifying the transactions within the block, ensuring they meet the network's consensus rules, and then permanently recording the block in the blockchain. The HybridDB supports the swap of roles between the Primary StateDB and the Shadow StateDB whenever necessary. Possible swap events are described below.

One swap event is based on failed block commits. If the Primary StateDB is currently set to be the secondary/asynchronous StateDB, and its height now matches the channel's height, the Primary StateDB is set as the current/synchronous StateDB, and the Shadow StateDB is set as the secondary/asynchronous StateDB. If the commit operation to the Primary StateDB fails, the peer waits for the Shadow StateDB to flush the asynchronous block commit queue, and then sets the Shadow StateDB as the current/synchronous StateDB and the Primary StateDB as the background/asynchronous StateDB.

Another swap event is based on a failure of a database transaction, such as the failure of an endorsement or a query execution. If the Primary StateDB is currently set to be the background/asynchronous StateDB, and its height now matches the channel's height, the Primary StateDB is set as the current/synchronous StateDB, and the Shadow StateDB is set as the background/asynchronous StateDB. If a database transaction against the Primary StateDB fails to be created, the peer waits for the Shadow StateDB to flush the asynchronous block commit queue and then sets the Shadow StateDB as the current/synchronous StateDB, and the Primary StateDB as the background/asynchronous StateDB.

Another swap event is based on the StateDB block height at peer startup. If the Primary StateDB's height is less than the ledger's height, and the Shadow StateDB's height matches the ledger's height, the Shadow StateDB is set as the current/synchronous StateDB, and the Primary StateDB is set as the background/asynchronous StateDB and instructed to perform asynchronous recovery from ledger blocks. For example, the ledger height corresponds to the latest block number. Thus, a StateDB height catches up to the ledger height when the latest block number processed by the StateDB is the same as the latest block in the ledger. In a possible implementation, the StateDB block height catches up when the latest block processed by one StateDB is equal to the latest block processed by the other StateDB, such as when the latest block processed by the background StateDB reaches the latest block processed by the current StateDB, which can invoke switching back from the Shadow StateDB to the Primary StateDB.

### Rich Queries and Custom Indexes in Hybrid DB

The permissioned blockchain system can support Rich Queries, custom-defined indexes specified using SQLite expressions, and other expressions that often do not match their semantically equivalent relational database expressions. In some cases, the semantic equivalent does not even exactly exist. For example, JavaScript Object Notation (JSON) expressions are one area where the dialects and expressions differ. The permissioned blockchain system uses an internal translation layer that is responsible for parsing the SQL expression(s) used as part of a Rich Query or a Custom Index definition. The translation layer builds the closest possible corresponding relational database SQL expression(s). The translation allows existing smart contracts to work unchanged across a traditional StateDB and a HybridDB StateDB, and it guarantees that queries will return the same results, equally efficiently, no matter whether the current StateDB is powered by the embedded DB or the relational database.

### Hybrid DB Queue Configuration

The HybridDB behavior can be tuned by changing metadata repository configurations. One possible configuration is <peer shared>/shadow_block_queue_size, which has a default value of 32768. This k/v controls the capacity of the queue used for asynchronous processing of blocks against the asynchronous StateDB. In the typical scenario where the relational database is the asynchronous StateDB, block processing against the Shadow StateDB can be significantly slower than against the Primary StateDB. That implies that in periods of intense transaction throughput, the Shadow StateDB may fall behind several blocks compared to the Primary StateDB's or ledger's block height. All blocks waiting for asynchronous processing will be waiting in a queue. Pull blocks are not just pulled from the ledger, because the blocks navigating through the commit pipeline can contain private information, which is best if it does not get lost (with the result of trying to partially pull it from other peers when needed). The queue can be large enough to allow for flexibility of Shadow StateDB in falling behind and catching up, but not too large to cause a big impact to used memory. While there is no perfect value that fits every use case, the default number can be large enough to cover most realistic use cases, and small enough not to cause a relevant memory impact. However, for use cases where the system needs to go through occasional high-volume transactions followed by lulls, a higher number may work better. If the queue is exhausted at any time, asynchronous block processing can be stopped, alerts are logged, and human intervention can be used to restart the peer, which would put Shadow StateDB in recovery mode and possibly change the queue length. Queue usage can be returned as part of the monitoring information.

### Example Methods

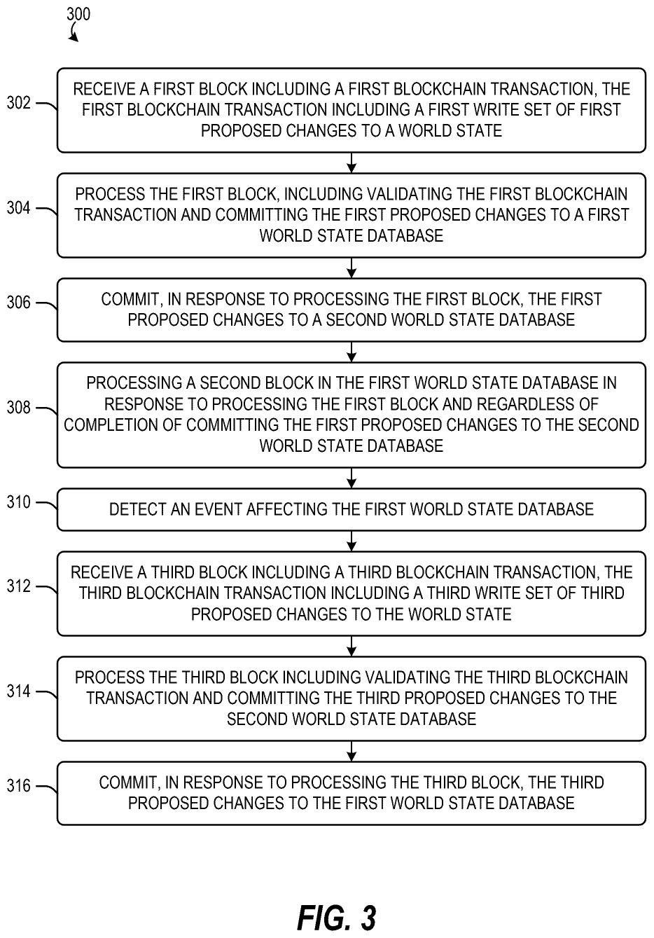

FIG. 3 is a flowchart 300 of a method for a HybridDB approach to represent a blockchain state of the world according to an example embodiment. The method is performed in a blockchain network, such as a permissioned blockchain system.

At 302, the method includes receiving a first block including a first blockchain transaction, the first blockchain transaction including a first write set of first proposed changes to a world state. The world state represents the current status of the blockchain. It is a snapshot that captures every account's balance, the status of every smart contract, and other information. The world state reflects all committed transactions on the blockchain. Every peer in the blockchain network maintains a copy of the world state, ensuring that there is a consensus on the state of affairs at any given moment.

At 304, the method includes processing the first block. Processing the first block includes validating the first blockchain transaction and committing the first proposed changes to a first world state database, such as the principally operating StateDB. For example, synchronous commits of changes from blocks to the first world state database are performed sequentially for each block. Processing of a subsequent block is not performed for the first world state database until processing of the immediately prior block is completed for the first world state database.

In an implementation, a blockchain transaction is considered committed when the transaction is validated and written to the blockchain ledger because it cannot be undone once written to the ledger. Committing is the task of validating each transaction in a block and applying the write sets associated with validated transactions to the state of the world. For example, a transaction includes a read set and a write set. The read set includes information, such as the version number used during endorsement. The version number can be important because part of the transaction validation verifies that the version number of the transaction is the same as the one that was accessed during endorsement. Then the peer flags the transaction as valid. Once the transaction is flagged as valid, the peer takes the write set, the set of key/values, from the transaction and updates the state of the world with the k/v pairs that are part of the write set. At that point, the commit phase is complete.

At 306, the method includes committing, in response to processing the first block, the first proposed changes to a second world state database, such as a background StateDB. In a possible implementation, committing the first proposed changes to the second world state database is performed without subsequent validation after validating the first blockchain transaction. For example, asynchronous commits of changes from blocks to the second world state database do not delay processing of data blocks for the first world state database. Thus, the asynchronous commits from a particular block to the second world state do not delay processing a subsequent block for commits to the first world state database.

At 308, the method includes processing a second block in the first world state database in response to processing the first block and regardless of the completion of committing the first proposed changes to the second world state database. In an example embodiment, the method includes receiving the second block including a second blockchain transaction, the second blockchain transaction including a second write set of second proposed changes to the world state. Processing the second block includes validating the second blockchain transaction and committing the second proposed changes to the first world state database. In an implementation, the processing of the second block occurs directly after processing the first block in the first world state database. The processing of the second data block is not blocked by or otherwise delayed specifically by initiation and/or completion of committing the changes specified by the first block (e.g. write set) to the second world state database. In other words, processing the second block is commenced regardless of the completion of committing changes specified by the first block to the second world state database. In this way, committing changes specified by the first block to the second world state database occurs asynchronously and may even be concurrent with processing the second block.

At 310, the method includes detecting an event affecting the first world state database. At 312, the method includes receiving, in response to detecting the event, a third block including a third blockchain transaction, the third blockchain transaction including a third write set of third proposed changes to the world state.

At 314, the method includes processing the third block. Processing the third block includes validating the third blockchain transaction and committing the third proposed changes to the second world state database, which can now be the principally operating StateDB. At 316, the method includes committing, in response to processing the third block, the third proposed changes to the first world state database, which can now be the background StateDB.

In an example implementation, the method also includes processing a fourth block in the second world state database in response to processing the third block and regardless of the completion of committing the third proposed changes to the first world state database. The fourth block can be processed in a similar manner to the second block.

In a possible implementation, the event is a failure of an attempt to commit proposed changes from a blockchain transaction against the first world state database. In a possible implementation, the event is a change event that changes a principally operating world state database to a background world state database. The change event can be a failure to create a database transaction against the principally operating world state database. The change event can be a primary world state database block height being less than a ledger block height at the startup of a corresponding peer. The change event can be a primary world state database block height catching up to the ledger block height when a shadow world state database is operating as the principally operating world state database. The change event can also be any other event that changes a principally operating world state database to a background world state database.

In a possible implementation, the first world state database is an embedded DB, such as the Primary StateDB, that stores data as key-value pairs. The second world state database is a relational database, such as the Shadow StateDB. The roles can be switched where the first world state database is the relational database and the second world state database is an embedded DB.

The first and second world state databases can also be any other database.

In a possible implementation, the method is performed by a peer of the blockchain network. The method further comprises designating the peer with a hybrid world state database configuration that commits blocks to the first world state database and to the second world state database.

In a possible implementation, the method includes placing the first block in a queue for the second world state database. The method includes retrieving the first block from the queue. Committing the first proposed changes to the second world state database is performed in response to retrieving the first block from the queue.

In a possible implementation, the method is performed by a peer of the blockchain network. The event includes restarting the peer and determining that the height of the first world state database is below the height of the ledger of the blockchain network. In a possible example, restarting the peer is performed in response to detecting that the first world state database is compromised, and deleting the compromised first world state database. For example, the ledger of the permissioned blockchain framework includes two parts: the blockchain and the StateDB. The blockchain contains the immutable history of all transactions, while the StateDB reflects the current state derived from these transactions. The StateDB holds the current values of all ledger states, making it easy to access the latest state of any business object without traversing the entire transaction history. The ledger height refers to the number of blocks that have been committed to the blockchain ledger. It typically indicates the current block number up to which the StateDB has been updated. When the StateDB is below the ledger height, it means that the StateDB has not yet been updated to reflect the latest committed block in the ledger. Essentially, the StateDB is lagging behind the ledger height, indicating that there are recent transactions or blocks that have been added to the ledger but not yet processed or reflected in the StateDB.

In a possible implementation, the method includes designating the first world state database as a principally operating world state database. The method includes designating the second world state database as a background world state database. The method includes, in response to detecting the event, designating the second world state database as the principally operating world state database, and designating the first world state database as the background world state database.

### DBMS Overview

A database management system (DBMS) manages a database. A DBMS may comprise one or more database servers. A database comprises database data and a database dictionary that are stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically-marked data objects; however, the hierarchically-marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

In a DOCS, a database command may be in the form of functions or object method calls that invoke CRUD (Create Read Update Delete) operations. An example of an A PI for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time.

An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snapshot time of the query. The DBMS determines which undo records to apply to a data block based on the respective logical times associated with the undo records.

When operations are referred to herein as being performed at commit time or as being commit time operations, the operations are performed in response to a request to commit a database transaction. DML commands may be auto-committed, that is, are committed in a database session without receiving another command that explicitly requests to begin and/or commit a database transaction. For DML commands that are auto-committed, the request to execute the DML command is also a request to commit the changes made for the DM L command.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables and other information.

A database server includes multiple database processes. Database processes run under the control of the database server (i.e. can be created or terminated by the database server) and perform various database server functions. Database processes include processes running within a database session established for a client.

A database process is a unit of execution. A database process can be a computer system process or thread or a user-defined execution context such as a user thread or fiber.

Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database.

Typically, the nodes are interconnected via a network and share access, in varying degrees, to shared storage, e.g. shared access to a set of disk drives and data blocks stored thereon. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the attribute names and data types of the attributes, and one or more files or portions thereof that store data for the table. Metadata in the database dictionary defining a procedure may specify a name of the procedure, the procedure's arguments and the return data type, and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e. .javafile) and the compiled version of the class (i.e. .classfile).

Native data types are data types supported by a DBMS “out-of-the-box”. Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as a valid data types and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

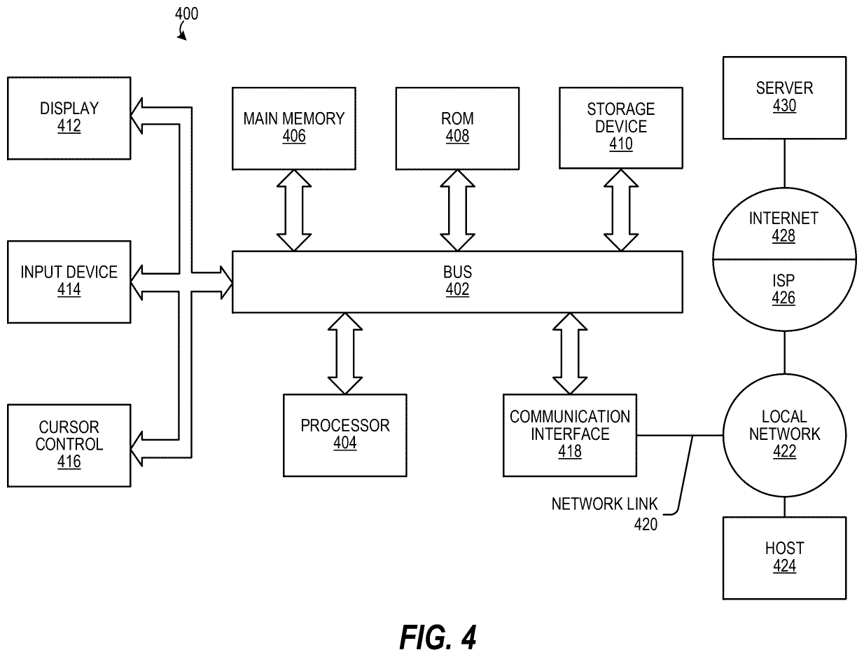

For example, FIG. 4 is a block diagram that illustrates a computer system 400 upon which aspects of the illustrative embodiments may be implemented. Computer system 400 includes a bus 402 or other communication mechanism for communicating information, and a hardware processor 404 coupled with bus 402 for processing information. Hardware processor 404 may be, for example, a general-purpose microprocessor.

Computer system 400 also includes a main memory 406, such as a random-access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412 for displaying information to a computer user. An input device 414, including alphanumeric and other keys, is coupled to bus 402 for communicating information and command selections to processor 404. Another type of user input device is cursor control 416, such as a mouse, a trackball, a touch screen, a track pad, and/or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and/or any other storage media.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem or send the instructions using a network. A receiver, such as a modem, local to computer system 400 can receive the data and use, for an example, an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented, such as to a wireless local area network (WLAN) or to a cellular network. In any such implementation, communication interface 418 sends and receives electrical, electromagnetic, radio, optical, and/or other signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world-wide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

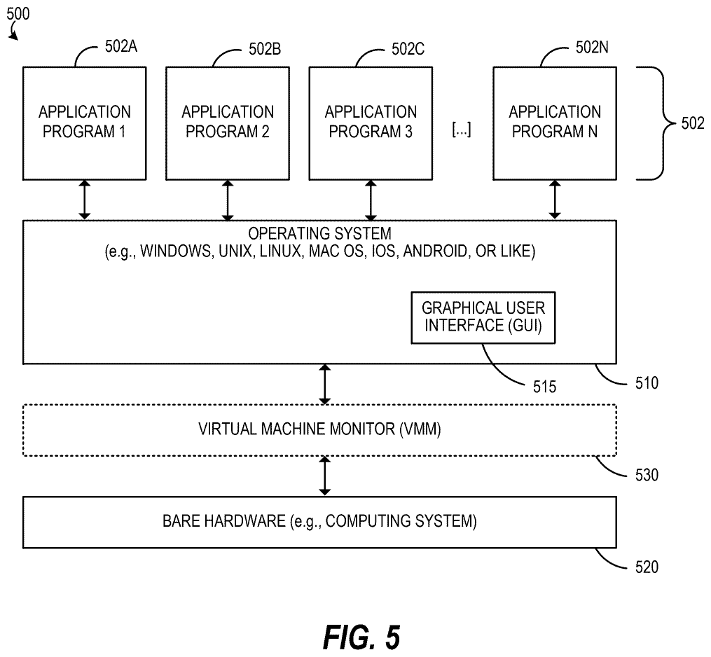

FIG. 5 is a block diagram of a basic software system 500 that may be employed for controlling the operation of computer system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computer system 400.

Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (Saas), in which consumers use software applications that are running upon a cloud infrastructure, while a SaaS provider manages or controls the underlying cloud infrastructure and applications.

Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method in a blockchain network, the method comprising:
receiving a first block including a first blockchain transaction, the first blockchain transaction including a first write set of first proposed changes to a world state;
processing the first block, where processing the first block includes:
validating the first blockchain transaction, and
committing the first proposed changes to a first world state database;
committing, in response to processing the first block, the first proposed changes to a second world state database;
processing a second block in the first world state database in response to processing the first block and regardless of completion of committing the first proposed changes to the second world state database;
detecting an event affecting the first world state database; and
in response to detecting the event,
receiving a third block including a third blockchain transaction, the third blockchain transaction including a third write set of third proposed changes to the world state;
processing the third block, where processing the third block includes:
validating the third blockchain transaction, and
committing the third proposed changes to the second world state database; and
committing, in response to processing the third block, the third proposed changes to the first world state database.

2. The method of claim 1, wherein the event comprises a failure of an attempt to commit proposed changes from a blockchain transaction against the first world state database.

3. The method of claim 1, wherein the event comprises a change event that changes a principally operating world state database to a background world state database, the change event being at least one selected from:
a failure to create a database transaction against the principally operating world state database,
a primary world state database block height being less than a ledger block height at a startup of a corresponding peer, and
a primary world state database block height catching up to the ledger block height when a shadow world state database is operating as the principally operating world state database.

4. The method of claim 1,
wherein the first world state database is an embedded database that stores data as key-value pairs; and
wherein the second world state database is a relational database.

5. The method of claim 1,
wherein the method is performed by a peer of the blockchain network,
wherein the method further comprises designating the peer with a hybrid world state database configuration that commits blocks to the first world state database and to the second world state database.

6. The method of claim 1, wherein committing the first proposed changes to the second world state database is performed without subsequent validation after the validating the first blockchain transaction.

7. The method of claim 1, further comprising:
placing the first block in a queue for the second world state database;
retrieving the first block from the queue; and
wherein committing the first proposed changes to the second world state database is performed in response to retrieving the first block from the queue.

8. The method of claim 1,
wherein the method is performed by a peer of the blockchain network, and
wherein the event comprises restarting the peer and determining that a height of the first world state database is below a height of a ledger of the blockchain network.

9. The method of claim 8, wherein restarting the peer is performed in response to detecting that the first world state database is compromised and deleting the compromised first world state database.

10. The method of claim 1, further comprising:
designating the first world state database as a principally operating world state database;
designating the second world state database as a background world state database; and
in response to detecting the event:
designating the second world state database as the principally operating world state database; and
designating the first world state database as the background world state database.

11. One or more non-transitory storage media storing one or more sequences of instructions which, when executed by one or more computing devices in a blockchain network, cause:
receiving a first block including a first blockchain transaction, the first blockchain transaction including a first write set of first proposed changes to a world state;
processing the first block, where processing the first block includes:
validating the first blockchain transaction, and
committing the first proposed changes to a first world state database;
committing, in response to processing the first block, the first proposed changes to a second world state database;
processing a second block in the first world state database in response to processing the first block and regardless of completion of committing the first proposed changes to the second world state database;
detecting an event affecting the first world state database; and
in response to detecting the event,
receiving a third block including a third blockchain transaction, the third blockchain transaction including a third write set of third proposed changes to the world state;
processing the third block, where processing the third block includes:
validating the third blockchain transaction, and
committing the third proposed changes to the second world state database; and
committing, in response to processing the third block, the third proposed changes to the first world state database.

12. The one or more non-transitory storage media of claim 11, wherein the event comprises a failure of an attempt to commit proposed changes from a blockchain transaction against the first world state database.

13. The one or more non-transitory storage media of claim 11, wherein the event comprises a change event that changes a principally operating world state database to a background world state database, the change event being at least one selected from:
a failure to create a database transaction against the principally operating world state database,
a primary world state database block height being less than a ledger block height at a startup of a corresponding peer, and
a primary world state database block height catching up to the ledger block height when a shadow world state database is operating as the principally operating world state database.

14. The one or more non-transitory storage media of claim 11,
wherein the first world state database is an embedded database that stores data as key-value pairs; and
wherein the second world state database is a relational database.

15. The one or more non-transitory storage media of claim 11,
wherein the one or more sequences of instructions are executed by a peer of the blockchain network,
wherein the instructions, when executed by the one or more computing devices, further cause designating the peer with a hybrid world state database configuration that commits blocks to the first world state database and to the second world state database.

16. The one or more non-transitory storage media of claim 11, wherein committing the first proposed changes to the second world state database is performed without subsequent validation after the validating the first blockchain transaction.

17. The one or more non-transitory storage media of claim 11, wherein the instructions, when executed by the one or more computing devices, further cause:
placing the first block in a queue for the second world state database;
retrieving the first block from the queue; and
wherein committing the first proposed changes to the second world state database is performed in response to retrieving the first block from the queue.

18. The one or more non-transitory storage media of claim 11,
wherein the one or more sequences of instructions are executed by a peer of the blockchain network, and
wherein the event comprises restarting the peer and determining that a height of the first world state database is below a height of a ledger of the blockchain network.

19. The one or more non-transitory storage media of claim 18, wherein restarting the peer is performed in response to detecting that the first world state database is compromised and deleting the compromised first world state database.

20. The one or more non-transitory storage media of claim 11, wherein the instructions, when executed by the one or more computing devices, further cause:
designating the first world state database as a principally operating world state database;
designating the second world state database as a background world state database; and
in response to detecting the event:
designating the second world state database as the principally operating world state database; and
designating the first world state database as the background world state database.
